(19) United States
(12) Patent Application Publication
(10) Pub. No.: US 2009/0060561 A1
(43) Pub. Date: Mar. 5, 2009

(54) IMAGE FORMING APPARATUS

(75) Inventor: Eiji OKABAYASHI, Toyokawa-shi (JP)

Correspondence Address: MORRISON & FOERSTER LLP, 1650 TYSONS BOULEVARD, SUITE 400, MCLEAN, VA, 22102, US

(73) Assignee: Knoica Minolta Business Technologies, Inc., Tokyo (JP)

(21) Appl. No.: 12/197,834

(22) Filed: Aug. 25, 2008

(30) Foreign Application Priority Data
Aug. 31, 2007 (JP) 2007-226176

(51) Int. Cl. G03G 21/20

(52) U.S. Cl. 399/94; 399/97

(57) ABSTRACT

An image forming apparatus is provided with a feed interval control section that sets feed intervals of the recording materials, for a defined period from immediately after completion of the warm-up operation for a fixing-side rotor and the pressure-side rotor determined by a warm-up completion determination section, to be longer than feed intervals of the recording materials posterior to the defined period in a high-humidity and low-temperature state. Thereby, the image forming apparatus prevents elongation of a warm-up time while achieving both reduction of the back curl and maintenance of fixability in the high-humidity and low-temperature state.

### CROSS-REFERENCE TO RELATED APPLICATION

This application is based on application No. 2007-226176 filed in Japan, the entire content of which is hereby incorporated by reference.

### BACKGROUND OF THE INVENTION

The present invention relates to an image forming apparatus such as an electrophotographic copying machine or a printer.

Generally, a belt fixing system is adopted to achieve a short warm-up time in fixing operation of an image forming apparatus. However, in order to further reduce the warm-up time, only a belt on the image surface side is heated in a short time. As a result, images are printed on paper sheets in a state where the pressure roller on the non-image surface side is low in temperature, immediately after the warm-up operation or the like.

It is known that the paper sheet is curled to the low-temperature side thereof with moisture when images are fixed in a large difference of temperature between the front and back surfaces of the paper sheet. In the belt fixing system, this phenomenon is called a back curl when the paper sheet is curled to the non-image surface side.

A large back curl is found particularly in recycled paper. The back curl is one of the problems which should be tackled at the present situation where recycling and energy saving are highly valued.

Conventionally, the belt fixing device in the image forming apparatus has employed a countermeasure to the back curl problem in an environment of 70% or more high humidity under a low temperature, in which the warm-up operation is completed when the low-temperature pressure roller is heated to a temperature higher than that in the normal environment less than 70% humidity (see JP 2005-189773 A).

However, there has been another problem that the warm-up time of the pressure roller in the high-humidity and low-temperature environment takes about 4 times longer than that in the normal environment. The warm-up time has increased from about 60 to about 240 seconds, as a specific example.

### BRIEF SUMMARY OF THE INVENTION

An object of the present invention is therefore to provide an image forming apparatus which prevents elongation of a warm-up time while achieving both reduction of a back curl and maintenance of fixability in a high-humidity and low-temperature state where humidity is equal to or above a specified value and temperature of a pressure roller is equal to or below a specified value.

In order to achieve the above-mentioned object, one aspect of the present invention provides an image forming apparatus that comprises a fixing-side rotor, a fixing-side heating section which heats the fixing-side rotor, a pressure-side rotor which comes into contact with the fixing-side rotor to form a nip section, a first temperature sensor which detects temperature of the fixing-side rotor, a second temperature sensor which detects temperature of the pressure-side rotor, a humidity sensor, a warm-up completion determination section which determines whether or not a warm-up operation for the fixing-side rotor and the pressure-side rotor has been completed based on an output of the first temperature sensor or outputs of the first temperature sensor and the second temperature sensor, and a feed interval control section which controls feed intervals of a recording material which passes the nip section in succession, wherein in a high-humidity and low-temperature state where humidity detected by the humidity sensor is equal to or above a specified value and temperature of the pressure-side rotor detected by the second temperature sensor is equal to or below a specified value, the feed interval control section sets feed intervals of the recording material for a defined period from immediately after completion of the warm-up operation for the fixing-side rotor and the pressure-side rotor determined by the warm-up completion determination section to be longer than feed intervals of the recording material posterior to the defined period.

According to the one aspect of the present invention, in the high-humidity and low-temperature state, the pressure-side rotor has a longer contact time with the fixing-side rotor. This makes the pressure-side rotor easily receive heat from the fixing-side rotor.

Thus, in the high-humidity and low-temperature state, temperature difference between the fixing-side rotor and the pressure-side rotor is decreased. Therefore, it becomes possible not only to reduce the back curl of the recording materials but also to maintain the temperature of the pressure-side rotor high. Thereby, deterioration of fixability is prevented, and it becomes unnecessary to heat the pressure-side rotor to sufficiently high temperature, resulting in prevention of the elongation of the warm-up time.

### BRIEF DESCRIPTION OF THE DRAWINGS

The present invention will become more fully understood from the detailed description given hereinbelow and the accompanying drawings which are given by way of illustration only, and thus are not limitative of the present invention, and wherein:

FIG. 1 shows a schematic diagram of an image forming apparatus in one embodiment of the present invention;

FIG. 2A shows a schematic diagram of a fixing device in a pressure contact state;

FIG. 2B shows a schematic diagram of the fixing device in a light pressure contact state;

FIG. 3 is a block diagram of a control device;

FIG. 4 is a graph showing temperature of components in a normal-humidity and low-temperature state;

FIG. 5 is a perspective view showing back-curl of paper sheets in a high-humidity and low-temperature state;

FIG. 6 is a graph showing temperature of the components in the high-humidity and low-temperature state as a comparative example;

FIG. 7 is a perspective view showing back-curl of paper sheets in the high-humidity and low-temperature state;

FIG. 8 is a graph showing temperature of the components in the high-humidity and low-temperature state;

FIG. 9 is a perspective view showing back-curl of paper sheets in the high-humidity and low-temperature state;

FIG. 10 is a graph showing the fixability without PPM control (100% paper feed) in the high-humidity and low-temperature state;

FIG. 11 is a graph showing the fixability with the PPM control of 70% in the high-humidity and low-temperature state;

FIG. 12 is a graph showing the fixability with the PPM control of 50% in the high-humidity and low-temperature state;

FIG. 13 is a graph showing the fixability with the PPM control of 50% and the PPM control of 70% in the high-humidity and low-temperature state;

FIG. 14 is a flow chart of a warm-up mode in the present invention; and

FIG. 15 is part of the flow chart of the warm-up mode in the present invention.

### DETAILED DESCRIPTION OF THE INVENTION

Hereinbelow, the present invention will be described in details in conjunction with the embodiments with reference to the drawings.

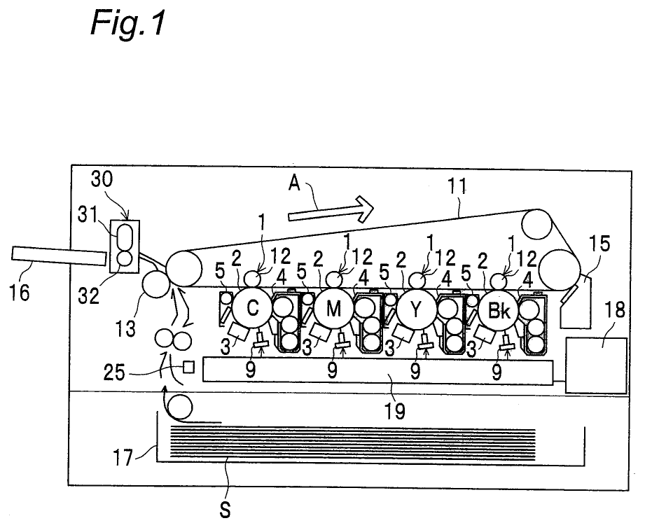

FIG. 1 is a simplified structure view of an image forming apparatus in one embodiment of the present invention. The image forming apparatus is a color printer having image forming units 1 of respective colors which form toner images of black (BK), yellow (Y), magenta (M) and cyan (C). An image forming unit 1 of BK, an image forming unit 1 of Y, an image forming unit 1 of M and an image forming unit 1 of C are placed sequentially from the upper stream along an intermediate transfer belt 11 which rotates in the direction of an arrow “A”.

The image forming unit 1 has a photoconductor drum 2, a charging section 3 for uniformly charging the photoconductor drum 2, an exposure section 9 for performing image exposure of the charged photoconductor drum 2, and a developing section 4 for developing an electrostatic latent image formed by the exposure with use of the toner of each color. The developed toner image is primarily transferred to the intermediate transfer belt 11 by a primary transfer section 12. After the primary transfer, the toner remaining on the photoconductor drum 2 is removed by a cleaning section 5 placed downstream and is collected from the lower side of the cleaning section 5.

The toner image developed on the photoconductor drum 2 in the image forming unit 1 is transferred onto the intermediate transfer belt 11 by the primary transfer section 12 at a contact position with the intermediate transfer belt 11. Whenever a toner image transferred on the intermediate transfer belt 11 passes each of the image forming units 1, respective colors are laid on top of each other, resulting in a full color toner image formed on the intermediate transfer belt 11.

Then, further in the downstream, the images are collectively transferred onto a recording material S such as paper sheets by a secondary transfer section 13. The toner images on the recording material S are fixed by passing through an upper fixing device 30, and then the recording material S is delivered onto a paper output tray 16. The fixing device 30 has a fixing-side rotor 31 and a pressure-side rotor 32.

Recording materials S, which are stored in a lowermost record sheet cassette 17, are transported to the transfer section 13, sheet by sheet. After the secondary transfer, the toner remaining on the intermediate transfer belt 11 is removed from the surface of the intermediate transfer belt 11 by using a cleaning blade 15. The toner is then transported with an unshown conveyance screw, before being collected in an unshown waste toner bottle.

A control device 18 controls the entire image forming apparatus (in this case, a color printer). From the control device 18, signals corresponding to images are sent to an exposure controller 19. The exposure controller 19 drives each of the exposure sections 9 according to respective colors.

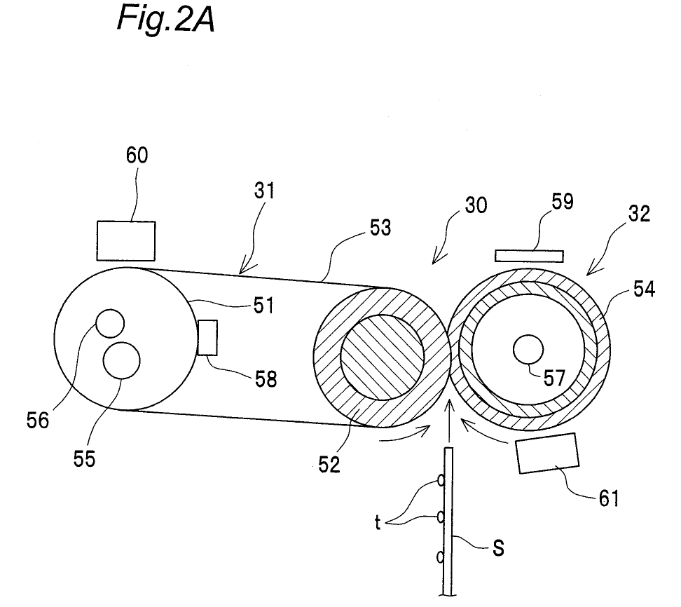

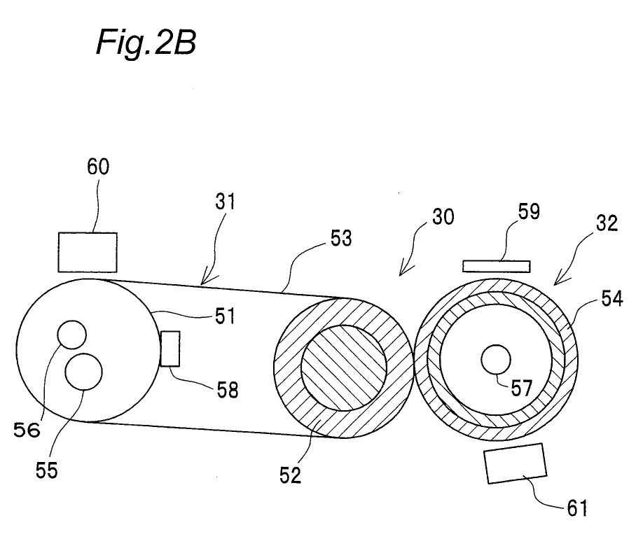

As shown in FIGS. 2A and 2B, the fixing device 30 has a fixing-side rotor 31 and a pressure-side rotor 32. The pressure-side rotor 32 comes into contact with the fixing-side rotor 31 to form a nip section. Toner t is fixed onto the recording material S in the nip section. The fixing-side rotor 31 is placed on the side of the toner t which is to be fixed onto the recording material S.

FIG. 2A shows a state of pressure contact between the rotors at the time of rotation, while FIG. 2B shows a state of light pressure contact therebetween at the time of stopping. The reason for the state of light pressure contact at the time of stopping is to prevent creep deformation of a fixing roller 52 having a sponge layer. The sate of light pressure contact is also used as a feed mode of envelope paper which would suffer paper wrinkling if the envelope paper is fed in the state of pressure contact.

The fixing-side rotor 31 has a heating roller 51, a fixing roller 52 and a fixing belt 53. The heating roller 51 is, for example, 30 mm in outer diameter and is 330 mm in axial length. The heating roller 51 includes an aluminum hollow core bar (0.6 mm in thickness), and a PTFE coat (15 micrometers in thickness). The fixing roller 52 is, for example, 30 mm in outer diameter, and includes an iron solid core bar (22 mm in diameter), a rubber (4 mm in thickness), and a sponge (2 mm in thickness). The fixing belt 53 is, for example, 60 mm in outer diameter, and includes a nickel base material (35 micrometers in thickness), a rubber (200 micrometers in thickness), and a PFA (30 micrometers in thickness).

The pressure-side rotor 32 has a pressure roller 54. The pressure roller 54 is, for example, 35 mm in outer diameter, and includes an iron hollow core bar (2.5 mm in thickness), a rubber (2.5 mm in thickness), and a PFA (30 micrometers in thickness).

A fixing-side heating section is provided to heat the fixing-side rotor 31. The fixing-side heating section is composed of a long heater 55 inside the heating roller (defined hereinafter as “heating-side”) and a heating-side short heater 56, which are incorporated in the heating roller 51. The heating-side long heater 55 is exemplified by a halogen lamp heater (1150 watts, emission length of 290 mm). The heating-side short heater 56 is exemplified by a halogen lamp heater (790 watts, emission length of 180 mm).

A pressure-side heating section is provided to heat the pressure-side rotor 32. The pressure-side heating section is constituted of a pressure-side heater 57 for the pressure roller, which heater is incorporated in the pressure roller 54. The heater 57 for the pressure roller is exemplified by a halogen lamp heater (230 watts, emission length of 290 mm). The fixing-side heating section and the pressure-side heating section are not turned on simultaneously. Specifically, they are so structured that ON-OFF control of the pressure-side heating section can be operated only when the fixing-side heating section is turned off in the state where the fixing-side heating section is subjected to ON-OFF control. In other words, current is preferentially passed to the fixing-side heating section, and then, the pressure-side heating section is not turned on whenever the fixing-side heating section is turned on.

A first temperature sensor is provided to detect the temperature of the fixing-side rotor 31. The first temperature sensor is constituted of a heating-side thermistor 58, which is placed in contact with the heating roller 51.

A second temperature sensor is provided to detect the temperature of the pressure-side rotor 32. The second temperature sensor is constituted of a thermistor 59 for the pressure roller, which is placed in non-contact with the pressure roller 54.

A heating-side thermostat 60 is provided to control the temperature of the fixing-side rotor 31. The heating-side thermostat 60 is placed 1 mm away from the fixing belt 53 near the center of the axial-direction of the fixing belt 53.

A pressure thermostat 61 is provided to control the temperature of the pressure-side rotor 32. The pressure thermostat 61 is placed 1 mm away from the pressure roller 54 near the center of the axial-direction of the pressure roller 54.

Description is given of the operation of the fixing device 30. An operation to heat the surface of the fixing belt 53 and the pressure roller 54 to printable temperature upon machine power-on is referred to as a warm-up operation. Time taken for the operation is referred to as warm-up time. The warm-up operation is performed in such occasions as the power source being turned on again after turned off, return from jam-treating operation, cover closing, and return from a sleep mode.

In the warm-up operation, the heating-side long heater 55 is turned on in order to raise the temperature to a printable temperature. In this case, the heating-side long heater 55 is maintained in the state of ON, and therefore the heater 57 for the pressure roller is put in the state of OFF.

At the stopping time, the pressure roller 54 and the fixing roller 52 are in a light pressure contact state for preventing creep deformation of the fixing roller 52. During rotation, the pressure roller 54 and the fixing roller 52 are put in the full pressure-contact state so that driving force is transmitted to an unshown drive gear. Thereby, the rotating pressure roller 54 is rotated to implement follower rotation of the fixing belt 53, the fixing roller 52 and the heating roller 51. Therefore, the heat of the heating roller 51 and the pressure roller 54 is transferred to the surfaces of the fixing belt 53 and the pressure roller 54.

Upon machine power-on, the heater is turned on and the roller starts to be rotated. Turning-on of the heater and rotation of the roller allow for heating the surfaces of the fixing belt 53 and the pressure roller 54 to a printable temperature. If both a temperature detected by the heating-side thermistor 58 and a temperature corrected in proportion to a non-contact portion after being detected by the pressure-side thermistor 59, then a “READY” flag is set to indicate that printing is operable. The “READY” flag is set, for example, when the temperature detected by the heating-side thermistor 58 is 190° C. and the corrected temperature of the temperature detected by the pressure-side thermistor 59 is 150° C.

If there is no print signal at this point, the fixing roller 52 and the pressure roller 54 are put in a light pressure contact state, so that the apparatus is in a printing standby state. On the other hand, if there is a print signal, the fixing roller 52 and the pressure roller 54 are put in a full pressure contact state, so that printing operation is started.

In the standby state, the fixing roller 52 and the pressure roller 54 usually stop rotating in a sate of light pressure contact, and the heaters 55, 56, 57 are controlled so as to gain certain preset temperatures. The preset temperature of the heating roller is 190° C. for example. The heating-side long heater 55 is on-off controlled by using, as an input, temperature detected by the heating-side thermistor 58. The preset temperature of the pressure roller 54 is 150° C. for example. The pressure-side heater 57 is on-off controlled by using, as an input, corrected temperatures obtained by correcting temperature detected by the pressure-side thermistor 59. In these cases, as mentioned above, the pressure-side heater 57 is not turned on when the heating-side long heater 55 is turned on.

In printing operation, after start of printing operation and before entering the recording material S into the fixing device 30, the fixing roller 52 and the pressure roller 54 rotate in full contact of each other under pressure. Thereby, the heat of the heating roller 51 is transferred to the pressure roller 54 via the fixing belt 53, so that temperature of the pressure roller 54 is increased. The preset temperature of the heating roller is 190° C. The heating-side long heater 55 or the heating-side short heater 56 is on-off controlled by using, as an input, temperature detected by the heating-side thermistor 58. The heating section to be selected is determined by an unshown heating section selection control section. Specifically, the heating section selection control section selects the heating-side short heater 56 when images are printed on recording sheets having a width of 216 mm or less, and selects the long heater 57 when images are printed on recording sheets having a width of more than 216 mm. The preset temperature of the pressure roller 54 is 150° C. The pressure heater 57 is on-off controlled by using, as an input, corrected temperatures obtained by correcting the temperature detected by the pressure-side thermistor 59.

In the case where the thermistor 58 fails to detect correct temperature due to some failures, the heating-side long heater 55 is left on, so that the heating roller 51 may be heated above the preset temperature, resulting in emission of smoke and ignition, for example. To avoid such an uncontrolled state of the heating roller, the heating-side thermostat 60 is placed as a protection section.

The heating-side thermostat 60 is electrically connected to the heating-side long heater 55 and the heating-side short heater 56 in series. As the result, whenever the heating-side thermostat 60 operates, electric power supply to the heating-side long heater 55 and the heating-side short heater 56 is cut off. Heat is transmitted from the heating roller 51 to the fixing belt 53 and from the fixing belt 53 to the heating-side thermostat 60. When the detection temperature of the heating-side thermostat 60 is preset to 210° C., the heating-side thermostat 60 operates upon reaching the temperature of 210° C. As the result, electric power supply to the heating-side long heater 55 or the heating-side short heater 56 is cut out to prevent further increase in temperature.

During warm-up operation, standby operation and normal paper feed operation, the heating-side long heater 55 is selectively turned on. On the other hand, during small size paper feed operation, the heating-side short heater 56 is selectively turned on to prevent temperature rise in axial ends of the heating roller 51. If the ends thereof are maintained at high temperature, the lifetime of the fixing device is deteriorated. Due to the presence of an axial uneven distribution of temperature, an uneven quality distribution of fixed image may be generated in the axial direction during feeding of the paper sheets. This may cause wrinkling of paper or other problems to be generated. Thus, it is preferable to provide a plurality of the heating sections in order to heat different heating regions.

In the case of measuring the temperature on the surface of the fixing belt 53, the temperature sensing device is sometimes provided in non-contact with the fixing belt 53 because the fixing belt 53 is damaged to cause an image noise by the temperature sensing device in contact with the surface of the fixing belt 53. However, the noncontact-type temperature sensing device is not preferable since it has a larger temperature gap in comparison with the contact-type device. In addition, the temperature of the fixing belt 53 in front of the nip section can be more stabilized by using temperature control based on detection of surface temperature of the heating roller 51 rather than that of the fixing belt 53. Therefore, it is preferable to place a contact-type thermistor 58 on the heating roller 51.

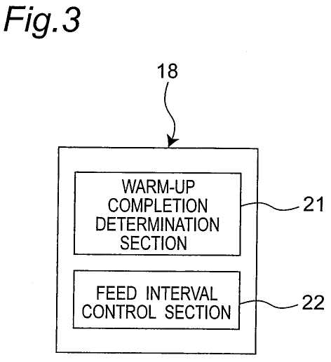

As shown in FIG. 1, the image forming apparatus of the present invention has a humidity sensor 25 inside thereof. As shown in FIG. 3, the control device 18 includes a warm-up completion determination section 21 and a feed interval control section 22.

The warm-up completion determination section 21 determines whether or not the warm-up operation for the fixing-side rotor 31 and the pressure-side rotor 32 is completed, based on the outputs of the heating-side thermistor 58 and the pressure-side thermistor 59. The feed interval control section 22 controls the feed intervals of the recording materials S which pass the nip section in succession.

In a high-humidity and low-temperature state, the feed interval control section 22 sets feed intervals of the recording materials S to be longer for a defined period than those intervals after the defined period from immediately after the warm-up completion determination section 21 determines completion of the warm-up operation for the fixing-side rotor 31 and the pressure-side rotor 32. Herein, the high-humidity and low-temperature state is defined as a sate that the humidity detected by the humidity sensor 25 is equal to or above a specified value and the temperature of the pressure-side rotor 32 detected by the pressure-side thermistor 59 is equal to or below a specified value.

The defined period may be composed of a plurality of periods. The feed intervals of the recording materials S may be different from each other in the plurality of periods. The feed intervals of the recording materials S in an anterior period among the plurality of periods may be longer than the feed intervals of the recording materials S in a posterior period. In other words, the defined period includes at least both a first period and a second period posterior to the first period, and the feed intervals of the recording materials S in the first period are longer than the feed intervals of the recording materials S in the second period.

The feed interval control section 22 may terminate the control over change in the feed intervals of the recording materials S after a fixed period from immediately after the warm-up completion determination section 21 determines the completion of the warm-up operation for the fixing-side rotor 31 and the pressure-side rotor 32. Alternatively, the feed interval control section 22 may terminate the control over change in the feed intervals of the recording materials S when it is determined that temperature difference between the fixing-side rotor 31 and the pressure-side rotor 32 is equal to or below a predetermined value on the basis of outputs of the heating-side thermistor 58 and the pressure-side thermistor 59. Alternatively, the feed interval control section 22 may terminate the control over change in the feed intervals of the recording materials S when it is determined that the temperature of the pressure-side rotor 32 is equal to or above the predetermined value on the basis of output of the pressure-side thermistor 59.

After the warm-up completion determination section 21 determines the completion of the warm-up operation, the temperature of the fixing-side rotor 31, which is during printing in the above-stated high-humidity and low-temperature state, may be lower than that in a normal-humidity and low-temperature state. The normal-humidity and low-temperature state is defined as a state that the humidity detected by the humidity sensor 25 is below a specified value and the temperature of the pressure-side rotor 32 detected by the pressure-side thermistor 59 is equal to or below a specified value.

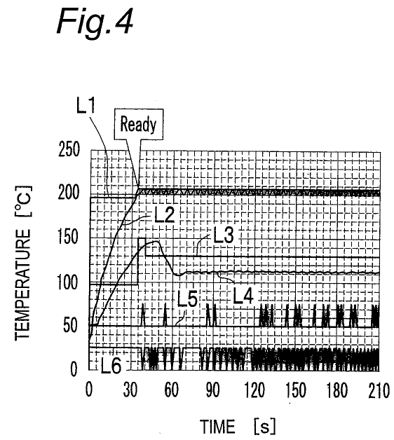

Description is given of the printing operation in the normal-humidity and low-temperature state. FIG. 4 shows temperatures in the normal-humidity and low-temperature state. A graph line L1 represents a preset temperature of the heating roller 51, and a graph line L2 represents the temperature of the heating roller 51. A graph line L3 represents a preset temperature of the pressure roller 54, and a graph line L4 represents the temperature of the pressure roller 54. A graph line L5 represents temperature in turning on and off of the pressure heater 57, and a graph line L6 represents temperature in turning on and off of the heating-side long heater 55 and the heating-side short heater 56.

At the moment when the temperature of the heating roller 51 reaches 195° C., the warm-up state for fixing is changed into a printing ready state, and then printing starts at heating temperature of about 205° C. As shown in FIG. 4, the temperature L4 of the pressure roller 54 is once decreased with progress of printing, so that a temperature difference between the pressure roller 54 and the heating roller 51 becomes as large as about 100° C.

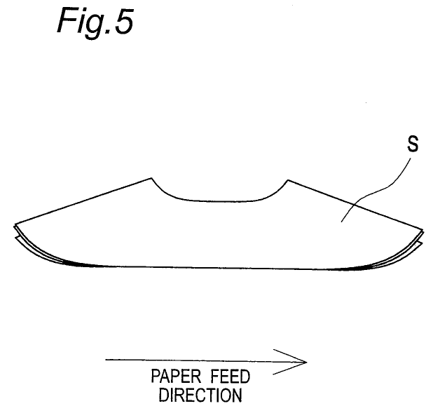

As a result, in the high-humidity and low-temperature state, the back curl of paper sheets, which are used as recording materials S, is increased as-shown in FIG. 5. A paper feed direction is shown with an arrow in FIG. 5.

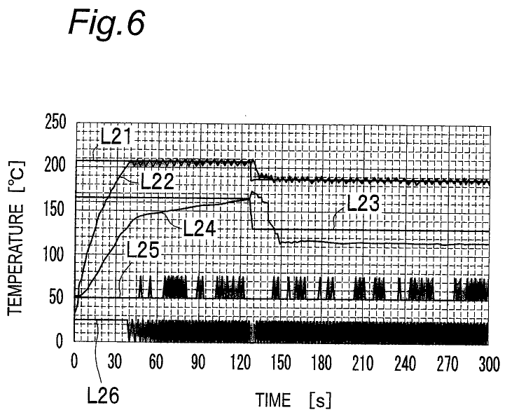

For a comparative example, description is given of the printing operation in the high-humidity and low-temperature state. FIG. 6 shows the temperature state in the normal-humidity and low-temperature state. A graph line L21 represents the preset temperature of the heating roller, and a graph line L22 represents the temperature of the heating roller. A graph line L23 represents the preset temperature of the pressure roller, and a graph line L24 represents the temperature of the pressure roller. A graph line L25 represents temperature in turning on and off of the pressure heater, and a graph line L26 represents temperature in turning on and off of the heating-side long heater and the short heater.

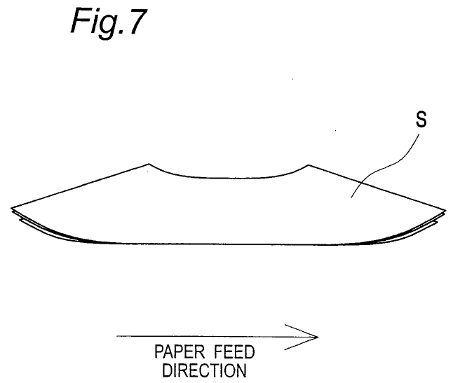

In the case were the temperature of the pressure roller is low and the humidity is equal to or above the specified value, the warm-up operation is conducted until the temperature L24 of the pressure roller becomes as high enough as 165° C. Since the fixing unit is sufficiently heated, the heating temperature required for printing can be set at 185° C. This temperature is lower than 205° C. set in the normal-humidity and low-temperature state shown in FIG. 4. Thus, the temperature of the fixing belt is lowered, and the temperature of the pressure roller is increased. Consequently, in the high-humidity and low-temperature state, the back curl of the paper sheets for recording materials S can be reduced, as shown in FIG. 7. A paper feed direction is shown with an arrow in FIG. 7. However, in the case of FIG. 6, a warm-up time is disadvantageously prolonged in order to make the temperature of the pressure roller sufficiently high.

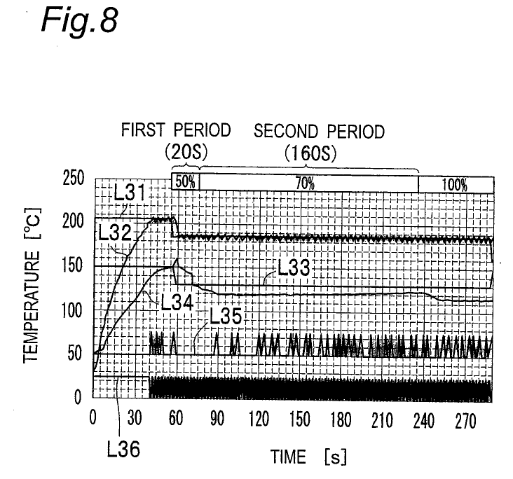

Description is given of the printing operation in the high-humidity and low-temperature state in the present invention. FIG. 8 shows the temperature state in the high-humidity and low-temperature state. A graph line L31 represents the preset temperature of the heating roller 51, and a graph line L32 represents the temperature of the heating roller 51. A graph line L33 represents the preset temperature of the pressure roller 54, and a graph line L34 represents the temperature of the pressure roller 54. A graph line L35 represents temperature in turning on and off of the pressure heater 57, and a graph line L36 represents temperature in turning on and off of the heating-side long heater 55 and the heating-side short heater 56.

In the case were the temperature of the pressure roller 54 is low and the humidity is equal to or above the specified value, the pressure roller 54 is heated to 150° C. This heating is such an extent that a warming time is not greatly increased in comparison with the case in the normal-humidity and low-temperature state shown in FIG. 4. Alternatively, the pressure roller 54 may be heated on the same conditions as the normal-humidity and low-temperature state shown in FIG. 4.

In FIG. 8, to enable fixing operation with the heating roller 51 at 185° C. which is lower than 205° C. in the normal-humidity and low-temperature state shown in FIG. 4, a larger paper interval is set by using the PPM control of 50% for 20 seconds, which is as a first period from immediately after determination of completion of the warm-up operation, so that the temperature of the pressure roller 54 may be kept high. Then, for 160 seconds as a second period, the PPM control of 70% is used to increase productivity and to maintain the fixability. Then, the PPM control is not used so as to conduct 100% printing. Herein, the PPM control is defined as controlling the number of paper sheets fed in one minute, and PPM is an abbreviation of Paper sheets Per Minute.

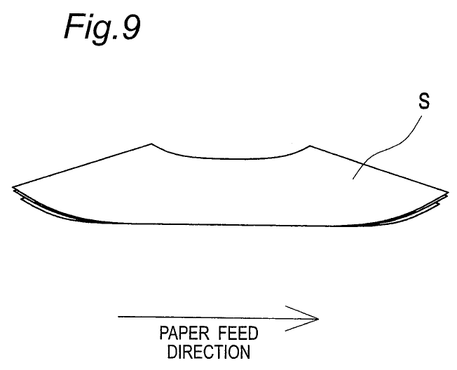

The PPM control periods immediately after the warm-up operation in the high-humidity and low-temperature are defined by the time after the warm-up operation. The PPM control does not start during those periods without a print command. In this case, while the temperature of the pressure roller 54 is kept high, the fixing operation is conducted. Therefore, as shown in FIG. 9, it is possible to achieve good fixability as well as reduction in the back curl of the paper sheets as recording materials S. In FIG. 9, a paper feed direction is shown with an arrow.

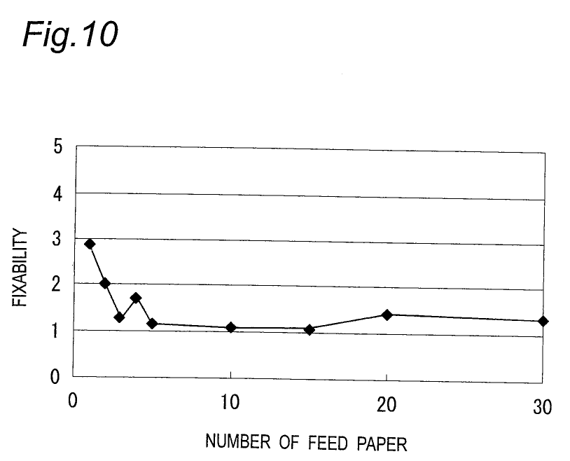

With reference to FIGS. 10 to 13, description is given of the relation between the PPM control and the fixability rank. In FIGS. 10 to 13, a horizontal axis represents the number of paper sheets fed, and a vertical axis represents fixability rank. The fixability rank is so defined that higher values indicate better fixability, in which rank 2 indicates good fixability.

FIG. 10 shows the fixability without PPM control (100% paper feed) in the high-humidity and low-temperature state, under the same warm-up conditions as those in FIG. 4 and at the temperature 185° C. of the heating roller 51. Since the heating roller temperature is as low as 185° C., fixability also gets worse with the decrease of the pressure roller temperature.

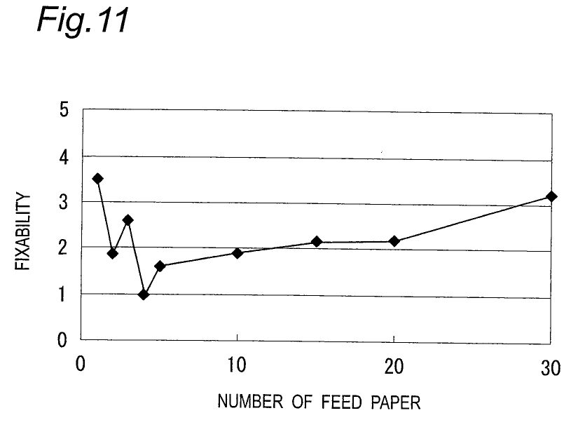

FIG. 11 shows the fixability under the PPM control of 70% in the high-humidity and low-temperature state. The fixability in early stages of printing still has room for improvement because the pressure roller temperature quickly falls.

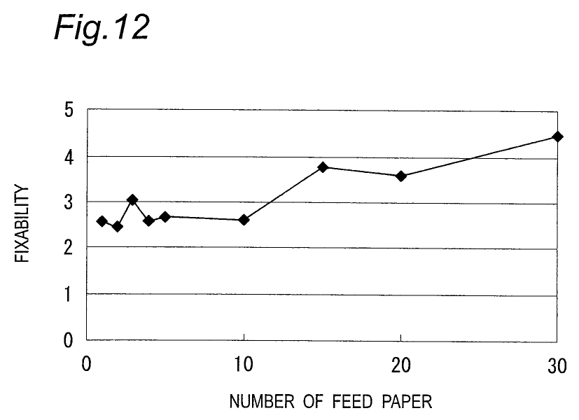

FIG. 12 shows the fixability with the PPM control of 50% in the high-humidity and low-temperature state. The PPM control of 50% has an effect on obvious improvement of the fixability in early stages of printing. But, it is desirable to keep the control period to the necessity minimum in order to suppress the degradation of productivity.

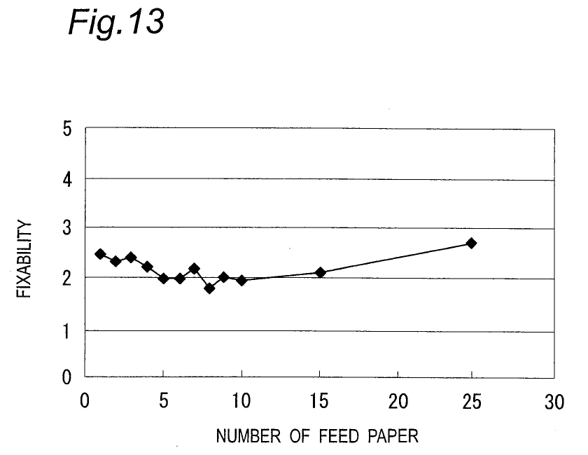

FIG. 13 shows the fixability in the case where the PPM control of 50% is applied for 20 seconds, and then the PPM control of 70% is applied for 160 seconds before 100% paper feed printing in the high-humidity and low-temperature state. This shows such a good result as the fixability is not much lower than the rank 2.

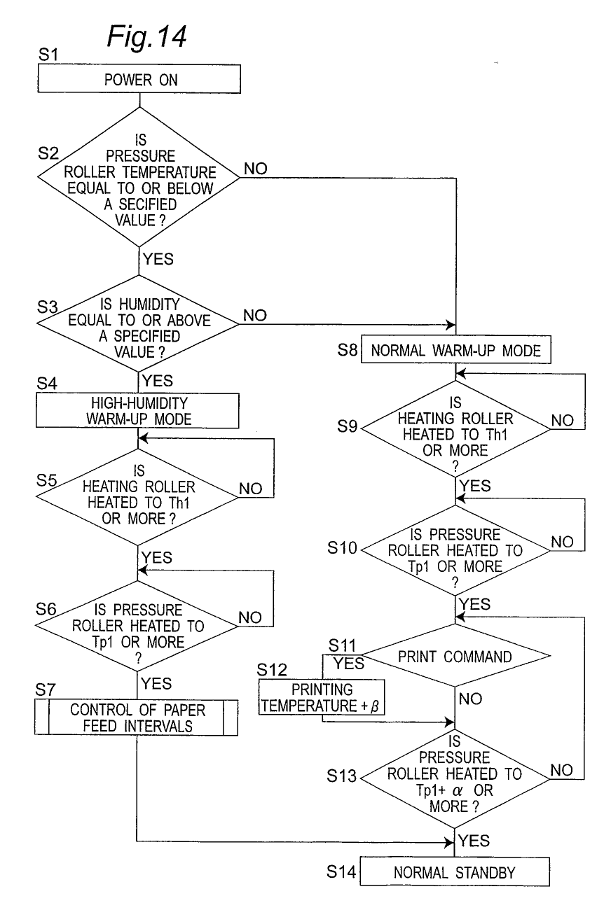

With reference to FIG. 14, description is given of the flow chart of a warm-up mode in the present invention.

First, a power supply is set to ON (Step S1). Then, it is determined whether or not the pressure roller temperature is equal to or below a specified value (Step S2).

If the pressure roller temperature is equal to or below the specified value, then it is determined whether or not the humidity is equal to or above a specified value (Step S3).

If the humidity is equal to or above the specified value, then a high-humidity warm-up mode is activated (Step S4). The heating roller is heated till its temperature reaches Th1 or more (Step S5). At the same time, the pressure roller is heated till its temperature reaches Tp1 or more (Step S6). Thereby, the warm-up operation is completed. Thereafter, paper feed intervals are controlled (Step S7), and then a standby mode is activated (Step S14).

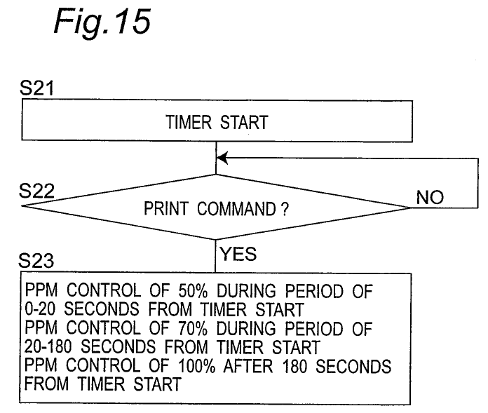

In the control on paper feed intervals (Step S7), a timer is started from completion of an warm-up operation (Step S21), as shown in FIG. 15. Next, if a print command is received (Step S22), then the PPM control of 50% is performed during a period of 0 to 20 seconds from the timer start, the PPM control of 70% is performed during a period of 20 to 180 seconds from the timer start, and the PPM control of 100% is performed after 180 seconds from the timer start (Step S23).

On the other hand, if the pressure roller temperature is not equal to or above a specified value (Step S2), or if the humidity is not equal to or above a specified value (Step S3), then a normal warm-up mode is activated (Step S8). Next, the heating roller is heated till its temperature reaches Th1 or more (Step S9). At the same time, the pressure roller is heated till its temperature reaches Tp1 or more (Step S10). Thereby, the warm-up operation is completed, and then the apparatus is set to wait for a print command (Step S11).

If a print command is given, the heating roller temperature is set at “printing temperature+β” (Step S12), and thereafter the pressure roller is heated till its temperature becomes “Tp1+α” or above (Step S13). Thereby the warm-up operation is completed, and then the apparatus is put in a normal standby state (Step S14). On the other hand, if no print command is given, the pressure roller is heated till its temperature becomes “Tp1+α” or more (Step S13). Thereby the warm-up operation is completed, and then the apparatus is put in the normal standby state (Step S14).

According to the above-structured image forming apparatus in the present invention, in the high-humidity and low-temperature state where the humidity detected by the humidity sensor 25 is equal to or above a specified value and the temperature of the pressure-side rotor 32 detected by the pressure-side thermistor 59 is equal to or below a specified value, the feed interval control section 22 sets the feed intervals of the recording materials S to be longer for a defined period than those intervals after the defined period from immediately after the completion of the warm-up operation for the fixing-side rotor 31 and the pressure-side rotor 32 determined by the warm-up completion determination section 21. Therefore, in the high-humidity and low-temperature state, the pressure-side rotor 32 has a shorter contact time with the recording material S and thereby is less susceptible to loss of heat by the recording material S, while the pressure-side rotor 32 has a longer contact time with the fixing-side rotor 31, and thereby can receive heat from the fixing-side rotor 31 more easily.

Therefore, in the high-humidity and low-temperature state, it becomes possible to decrease temperature difference between the fixing-side rotor 31 and the pressure-side rotor 32, so that the back curl of the recording material S is not only reduced but also the temperature of the pressure-side rotor 32 is kept high. Also, deterioration of fixability is prevented, and thereby it becomes unnecessary to heat the pressure-side rotor 32 to sufficiently high temperature, resulting in prevention of elongation of the warm-up time.

According to the above-structured image forming apparatus, the feed intervals of the recording materials S in a plurality of the periods are different from each other, and the feed intervals of the recording materials S in an anterior period among a plurality of the periods are longer than the feed intervals of the recording materials S in a posterior period. As a result, the fixability of the recording material S and productivity can both be achieved.

According to the image forming apparatus in the present invention, the feed interval control section 22 terminates the control over change in the feed intervals of the recording materials S after a fixed period from immediately after the warm-up completion determination section 21 determines the completion of the warm-up operation for the fixing-side rotor 31 and the pressure-side rotor 32. Therefore, the productivity of the recording material S is scarcely reduced.

According to the above-structured image forming apparatus, the feed interval control section 22 terminates the control over change in the feed intervals of the recording materials S when it is determined that temperature difference between the fixing-side rotor 31 and the pressure-side rotor 32 is equal to or below a predetermined value on the basis of the outputs of the heating-side thermistor 58 and the pressure-side thermistor 59. Therefore, the productivity of the recording material S is scarcely reduced.

According to the above-structured image forming apparatus, the feed interval control section 22 terminates the control over change in the feed intervals of the recording materials S when it is determined that the temperature of the pressure-side rotor 32 is equal to or above the predetermined value on basis of the output of the pressure-side thermistor 59. Therefore, the productivity of the recording material S is scarcely reduced.

According to the above-structured image forming apparatus, the temperature of the fixing-side rotor 31 during printing after completion of the warm-up operation determined by the warm-up completion determination section 21 in the high-humidity and low-temperature state is lower than the temperature of the fixing-side rotor 31 during printing after completion of the warm-up operation determined by the warm-up completion determination section 21 in the normal-humidity and low-temperature state. Therefore, it becomes possible to achieve further reduction of temperature difference between the fixing-side rotor 31 and the pressure-side rotor 32, and further reduction of the back curl of the recording material S.

The present invention should not be limited to the above-described embodiments. For example, the pressure-side rotor 32 may be heated via the fixing-side rotor 31 by only the fixing-side heating section (heaters 55 and 56), without the pressure-side heating section (the pressure heater 57). Also, the fixing-side rotor 31 may be formed into a roller, and the pressure-side rotor 32 may be formed into a belt. The fixing-side heating section and the pressure-side heating section may be so structured as to be heated by electromagnetic induction instead of the commonly-used heater. Further, the first temperature sensor and the second temperature sensor may be constituted by thermocouples instead of thermistors. The image forming apparatus may be any apparatus including monochrome/collar copying machines, printers, facsimiles, and multi-functional machines having their functions.

The invention being thus described, it will be obvious that the invention may be varied in many ways. Such variations are not be regarded as a departure from the spirit and scope of the invention, and all such modifications as would be obvious to one skilled in the art are intended to be included within the scope of the following claims.

What is claimed is:

1. An image forming apparatus, comprising:
a fixing-side rotor;
a fixing-side heating section which heats the fixing-side rotor;
a pressure-side rotor which comes into contact with the fixing-side rotor to form a nip section;
a first temperature sensor which detects temperature of the fixing-side rotor;
a second temperature sensor which detects temperature of the pressure-side rotor;
a humidity sensor;
a warm-up completion determination section which determines whether or not a warm-up operation for the fixing-side rotor and the pressure-side rotor has been completed based on an output of the first temperature sensor or outputs of the first temperature sensor and the second temperature sensor; and
a feed interval control section which controls feed intervals of a recording material which passes the nip section in succession, wherein
in a high-humidity and low-temperature state where humidity detected by the humidity sensor is equal to or above a specified value and temperature of the pressure-side rotor detected by the second temperature sensor is equal to or below a specified value, the feed interval control section sets feed intervals of the recording material for a defined period from immediately after completion of the warm-up operation for the fixing-side rotor and the pressure-side rotor determined by the warm-up completion determination section to be longer than feed intervals of the recording material posterior to the defined period.

2. The image forming apparatus set forth in claim 1, wherein
the defined period includes a plurality of periods,
feed intervals of the recording material in a plurality of the periods are different from each other, and
the feed intervals of the recording material in an anterior period among a plurality of the periods are longer than the feed intervals of the recording material in a posterior period.

3. The image forming apparatus set forth in claim 1, wherein
the feed interval control section terminates control over change in the feed intervals of the recording material after a fixed period from immediately after completion of the warm-up operation for the fixing-side rotor and the pressure-side rotor determined by the warm-up completion determination section.

4. The image forming apparatus set forth in claim 1, wherein
the feed interval control section terminates control over change in the feed intervals of the recording material when it is determined that temperature difference between the fixing-side rotor and the pressure-side rotor is equal to or below a predetermined value, based on the outputs of the first temperature sensor and the second temperature sensor.

5. The image forming apparatus set forth in claim 1, wherein
the feed interval control section terminates control over change in the feed intervals of the recording material when it is determined that the temperature of the pressure-side rotor is equal to or above the predetermined value based on the output of the second temperature sensor.

6. The image forming apparatus set forth in claim 1, wherein
temperature of the fixing-side rotor during printing after completion of the warm-up operation determined by the warm-up completion determination section in the high-humidity and low-temperature state is lower than temperature of the fixing-side rotor during printing after completion of the warm-up operation determined by the warm-up completion determination section in a normal-humidity and low-temperature state where humidity detected by the humidity sensor is below a specified value and temperature of the pressure-side rotor detected by the second temperature sensor is equal to or below a specified value.

7. The image forming apparatus set forth in claim 1, wherein
the pressure-side rotor is heated by the fixing-side heating section via the fixing-side rotor.

8. The image forming apparatus set forth in claim 1, comprising
a pressure-side heating section which heats the pressure-side rotor, wherein
the fixing-side heating section and the pressure-side heating section are not turned on simultaneously.
